(19) United States
(12) Patent Application Publication
(10) Pub. No.: US 2010/0178399 A1
(43) Pub. Date: Jul. 15, 2010

(54) Method and composition for tenderizing meat

(76) Inventors: Percy L. Square, Dacula, GA (US); Michelle B. Square, Dacula, GA (US)

Correspondence Address: PERCY L. SQUARE, ESQ, 2379 APACACHEE CRUCIS LANE, DACULA, GA, 30019, US

(21) Appl. No.: 12/319,762

(22) Filed: Jan. 12, 2009

(51) Int. Cl. A23C 9/154; A23L 1/01; A23D 9/007

(52) U.S. Cl. 426/302; 426/601; 426/585

(57) ABSTRACT

The present application relates to an adhesive paste and a method of using an adhesive paste for tenderizing meat, comprising providing a suitable amount of meat and providing a paste having a consistency which enables it to adhere to a surface of the meat with minimal dripping or running, applying the paste to at least a lower surface of the meat and exposing the meat to a heat source for cooking and the meat is tenderized during cooking.

### BACKGROUND OF THE INVENTION

1. Field of the Invention

The present invention relates to meat tenderizing, and more particularly to a paste adhered to a surface of a meat, exposing the meat to a heat source for cooking wherein the meat is tenderized during cooking.

2. Discussion of the Background Art

From commercial cooking establishments to backyard barbecue enthusiasts, meeting a challenge of obtaining a tender and flavorful cooked meat product over a heated apparatus such as a barbecue pit has been difficult. The difficulty is somewhat due a fact that in order to obtain a desired flavor and tenderness, meat is usually suspended or semi-suspended over a heat source which is suitable for adding wood or charcoal flavoring to the meat. Such a type of heat source can easily dry the meat out or burn the meat. A dry and tough meat or a burnt meat is not pleasing to eat. Tenderizing standard or cheap over-the-counter cuts of meats (pork and beef, for example) which have not been subjected to an expensive tenderizing process may be more challenging. In the case of slabs of meat, (pork rib racks, slabs, for example) a known method of obtaining tender and flavorful ribs is to slowly cook the slab or rack of pork ribs over low heat such as smoldering coals for as long as up to 12 hours. During long cooking times, moisture is usually added from an external source at regular intervals either directly to the surface of the meat, or into the heated environment in which the meat is being cooked. Moisture in the form of a pourable liquid is sometimes added to a type of reservoir located within a cooking apparatus. The addition of moisture is based on a practice and belief that a key to obtaining moist, tender meat is to maintain a low heat and to provide a continuously renewed moisture source to the meat for a duration of a cooking time of the meat. If a wood smoke or charcoal flavor is desired, chips, chunks of wood or charcoals must be added at intervals over an entire cooking period. In a case of wood or charcoal generated heat, the fire must be tended continually to keep it burning over long periods of time. During this process, the barbecue pit or cooking apparatus must be opened and closed many times, which causes loss of smoke, and also loss of moisture. It is difficult to maintain a consistent cooking temperature under these circumstances. This method is disadvantageous in that it requires a considerable amount of skill, time and human intervention.

Another known approach to meat tenderization is tenderization using enzymes (proteolytic enzymes, for example). According to this method, enzyme-containing compositions are applied directly to a surface of a meat. The meat is then allowed to marinade for a period of time. Many enzymes are activated at a first temperature and deactivated at a second temperature. In an activated temperature zone, enzymes cause degradation of protein which results in tenderization of the meat. A drawback to enzyme tenderization is that the enzyme may not be uniformly dispersed on or in the meat, and therefore the meat is non-uniformly tenderized. In other words, over-tenderization occurs in some portions of the meet and under-tenderization occurs in other portions of the meat. In a case of over-tenderization, some or all portions of the meat may be mushy, and in a case of under-tenderization, some or all portions of the meat may be tough. Also, enzymes lose effectiveness at tenderizing once they reach a deactivation temperature. Some enzymes are deactivated at temperatures as low as 160 degrees F. (bromelain, for example). Papain is deactivated at temperatures as low as 170 degrees F., for example. Therefore these and other enzymes are ineffective for tenderizing above particular temperatures.

Enzyme based tenderizers are available in retail establishments. Many are in granulated form. These tenderizers usually include an enzyme such as papain and bromelain, for example. A major complaint with these tenderizers is that they may taste very salty, and may render a meat too salty to be enjoyed. Also, uniformity is hard to control, and the meat may be mushy on the outer surface and not tenderized internally. In other words, uniform tenderization is difficult to obtain.

Other methods require that the meat, ribs, for example, is pre-cooked in liquid solutions for long periods of time, or pre-boiled prior to grilling in order to obtain a tender product. This is a very time consuming process and very expensive, both for commercial establishments and for non-commercial cooking. Pre-boiling may also result in the loss of the natural flavor of the meat.

Still other known methods of tenderizing require beating meat with a mallet, cutting meat into small chunks or cubes, grinding or mincing meat, or cutting meat into thin pieces.

Therefore, it would be useful to have a method of tenderizing meat so that larger cuts of meat can be cooked and tenderized quickly using simple methods, and which result in a cooked product that is consistently tender, flavorful and suitable for human consumption. Therefore, there is a need for a composition and method of tenderizing meat that reduces costs, eliminates long preparation and cooking times, and produces a product that is flavorful and uniformly tender.

### SUMMARY OF THE INVENTION

Accordingly, the present invention is directed to a composition and method of tenderizing meat that substantially obviate one or more problems due to limitations and disadvantages of the background art.

An object of the present invention is to provide a composition and method of effectively moisturizing and tenderizing meat while providing and preserving flavor and moisture.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the features particularly pointed out in the written description and claims hereof as well as the appended drawings.

To achieve these objects and other advantages and in accordance with the purpose of the invention, as embodied and broadly described herein, there is provided a method of using an adhesive paste for tenderizing meat, the method comprising: providing a suitable amount of meat; providing an adhesive paste, the adhesive paste having a consistency which enables it to adhere to a surface of the meat with minimal dripping or running; applying the adhesive paste to at least a lower surface of the meat; and exposing the meat to a heat source for cooking, wherein the meat is tenderized during cooking and wherein a consistency of the adhesive paste is such that it adheres to a surface of the meat with minimum dripping or running, and wherein the adhesive paste is applied to the meat before exposing the meat to the heat source for cooking, and wherein the adhesive paste is applied to an entire surface of the meat and wherein the adhesive paste is not used with a tenderizing enzyme and wherein the adhesive paste tenderizes the meat outside of an active temperature range of a tenderizing enzyme and wherein the adhesive paste is slow dissipating, and wherein the adhesive paste is slow melting and wherein the adhesive paste is slow evaporating and wherein the adhesive paste leaves a residue, and wherein the adhesive paste dissipates substantially during cooking, and wherein the adhesive paste tenderizes the meat based on a thickness of an application of the paste, and wherein the adhesive paste tenderizes the meat based on a duration of time of adhesion of the paste to the meat, and wherein the adhesive paste tenderizes the meat based on a type of meat, and wherein the adhesive paste tenderizes the meat based on a size of the meat, and wherein the adhesive paste tenderizes the meat based on a thickness of the meat, and wherein the adhesive paste tenderizes the meat based on a shape of the meat, and wherein the meat is in slab form, and wherein the adhesive paste tenderizes the meat based on duration of time of cooking the meat, and wherein the adhesive paste tenderizes the meat in less than 15 minutes, and wherein the adhesive paste tenderizes the meat in less than 30 minutes, and wherein the adhesive paste tenderizes the meat in less than 45 minutes, and wherein the adhesive paste tenderizes the meat at cooking temperatures based on a cooking temperature of the meat, and wherein the heat source for cooking includes heat provided by gas, charcoal, wood, flame or electricity, and wherein the heat source is provided beneath a lower surface of the meat, and wherein the heat source is provided by a barbecue grill, barbeque pit, smoker, oven, rotisserie or open fire, and wherein the adhesive paste tenderizes the meat at temperature which exceeds an activation temperature of an enzyme used for tenderizing, and wherein the adhesive paste tenderizes the meat irrespective of a presence of a tenderizing enzyme or of a special composition of the paste, and when the paste does not have a tenderizing enzyme, and wherein the adhesive paste tenderizes the meat irrespective of pre-marinating the meat, and when the meat has not been marinated.

There is also provided an adhesive paste for tenderizing meat, comprising a plant oil; and a thickener of the plant oil, wherein the plant oil and the thickener are blended together to form an adhesive paste, the adhesive paste having a consistency which enables it to adhere to a surface of a meat with minimal dripping or running.

There is further provided an adhesive paste for tenderizing meat, comprising: a plant oil; and a plant paste, wherein the plant oil and the plant paste are blended together to form an adhesive paste, the adhesive paste having a consistency which enables it to adhere to a surface of a meat with minimal dripping or running.

There is further provided an adhesive paste for tenderizing meat, comprising: a dairy product; an emulsion, wherein the dairy product and the emulsion are blended together to form an adhesive paste, the adhesive paste having a consistency which enables it to adhere to a surface of a meat with minimal dripping or running.

There is further provided an adhesive paste for tenderizing meat, comprising a dairy product; and a plant paste, wherein the dairy product and the plant paste are blended together to form an adhesive paste, the adhesive paste having a consistency which enables it to adhere to a surface of a meat with minimal dripping or running.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention, and together with the description serve to explain the principle of the invention.

In the drawings:

FIG. 1 illustrates an example of a meat.

FIG. 2 illustrates an example of a meat with an adhesive paste adhered to a lower surface.

FIG. 3 illustrates an example of a meat with an adhesive paste applied to an upper surface and a lower surface.

FIG. 4 is a graph illustrating a thickness of a meat versus a thickness of an adhesive paste.

FIG. 5 illustrates an example of a meat being cooked with a heat source.

FIG. 6 illustrates an example of a meat on a support.

### DETAILED DESCRIPTION OF PREFERRED EMBODIMENTS

Reference will now be made in detail to preferred embodiments of the present invention, examples of which are illustrated in the accompanying drawings. Wherever possible, the same reference numerals will be used throughout the drawings to refer to the same or like parts.

### Composition of Paste

An adhesive paste according the present invention may have the following compositions, all components thereof being edible:
1. plant oil (vegetable, fruit, nut) 65-99%
   egg product 1-10%
2. plant oil (vegetable, fruit, nut) 5-64%
   egg product 1-10%
   plant paste (vegetable, fruit, nut) 30-80%
   balance flavorings and stabilizers
3. plant oil (vegetable, fruit, nut), 5-50%
   egg product 1-10%
   milk dairy product 50-95%
4. plant paste (vegetable, fruit, nut) 5-75%
   milk dairy product 5-75%
   balance flavorings and stabilizers.
5. plant oil (vegetable, fruit, nut) 5-65%
   egg product 1-10%
   milk dairy product 50-95%.

In addition to the components, listed in 1-5 above, animal oil may be used with or in substitute for a quantity of plant oil. Flavorings and stabilizers may also be added in accordance with a desired taste or color, or in accordance with a regulatory requirement. Juice from fruit and vegetables may be included in an oil according to the present invention.

For purposes of this application, a plant oil may include apricot kernel oil, avocado oil, canola oil, cocoa oil, coconut oil, corn oil, cottonseed oil, grapeseed oil, hazelnut oil, horse radish oil, linseed oil, mustard oil, olive oil, palm oil, palm kernel oil, peanut oil, rapeseed oil, rice bran oil, safflower oil, sesame oil, sheanut oil, soybean oil, sunflower oil, teaseed oil, vegetable oil and walnut oil, for example. Any imitations or substitutes of the foregoing may be used, for example. Juices from the fruit and vegetables may be included in the oil from the foregoing.

An animal oil may include a dairy product, an animal product animal fat, animal oil, butter, buttermilk, cod liver oil, ghee, lard, marine oils, fish oils, pork lard, salt pork oil, shortening or imitations, extracts or substitutes of the foregoing, for example.

For purposes of this application, a plant paste may include a paste made from any edible vegetable, nut or fruit or seeds thereof, and any substitutes thereof. Nuts and seeds include almonds, beechnuts, brazil nuts, cashews chestnuts, coconut, filberts, hazelnuts, hickory nuts, macadamia nuts, peanuts, pecans, pine nuts, pistachio nuts, pumpkin seeds, sesame seeds, sunflower seeds, and walnuts, for example. Any nut or seed capable of being used to form a plant paste may be used.

Fruits which may be used to make a plant paste according to the present invention may include apples, apricots, berries, grapes, persimmons, plums, cherries, raspberries, blueberries, cranberries, figs, pears, tomatoes, raisins, strawberries, bananas, guava, for example.

Vegetables which may be used to make a plant paste according to the present invention may include vegetables of fruit of trees, leafy and salad vegetables, fruiting and flowering vegetables, podded vegetables, bulb and stem vegetables, root and tuberous vegetables and sea vegetables, for example. Vegetables which may be used according to the present invention include avocado, breadfruit, squash, bell pepper, melon, cayenne pepper, chili pepper, ccucumber, pumpkin, squash, corn, sweetcorn, sweet pepper, tomato, winter melon, zucchini, black-eyed pea, chickpea, french bean, lentil, okra, pea, soybean, asparagus, celery, garlic, kohlrabi, lotus root, onion, asparagus, shallot, onion, leek, bamboo shoot, beetroot, carrot cassava, ginger, parsley, jicama, parsnip, pignut, potato radish, rutabaga, wasabi, water chestnut and yam, for example. An egg product according to the present invention includes eggs and egg yolk. Egg yolk can be in any of the usual forms of egg yolk, such as liquid egg yolks, frozen egg yolks, rehydrated dried egg yolk, liquid whole eggs, frozen whole eggs, rehydrated dried whole eggs or any of the foregoing combined with liquid egg whites or frozen egg whites. Any thickening or emulsifying products can be used in substitution for egg product emulsifiers, as long as the desired adhesion properties can be obtained. Gum acacia, carob bean gum, guar gum, gum karaya, gum tragacanth, carrageenan, pectin, propylene glycol ester of alginic acid, sodium carboxymethylcellulose or any mixture of two or more of these can be used as thickeners, emulsifiers and/or stabilizers to achieve the desired degree of adhesion, for example.

A milk dairy product according to the present invention may include milk from a mammal, for example. A milk dairy product according to the present invention may include sour cream, clotted cream, buttermilk, fermented milk, milk powder, whole milk, cream, condensed milk, evaporated milk, cheese, infant formula, boiled milk, butter, buttermilk, ghee, milkfat, curds, whey, milk protein concentrates, yogurt, ice cream, ice milk and custard, for example.

Flavorings may include salt, sugar or other sweetening ingredient, mustard, paprika or other spice or spice extract, mustard, garlic, cloves, onion, monosodium glutamate and any suitable, harmless food seasoning or flavoring. Other additives may include vinegar, lemon juice, soy sauce and molasses.

### Method of Forming an Adhesive Paste

### First Embodiment

An adhesive paste according to a first embodiment of the present invention may be formed by blending plant oil and a thickener or emulsifying agent of the plant oil in proportions that will result in a paste that adheres to a desired meat with minimum dripping or running. For purposes of this application, minimum dripping or running is that the paste will adhere to the meat and a desired thickness of the paste for tenderizing will remain on the surface of the meat at the time that cooking of the meat commences. For example, when a 1/16^{th} inch thickness of adhesive paste is appropriate for tenderizing a certain thickness of meat, a 1/16^{th} inch thickness should remain on the meat substantially. An adhesive paste according an embodiment of the present invention can be formed by combining egg product (containing the emulsifier lecithin, for example) with the plant oil. The ratio by weight of the egg product and the plant oil can be 1-10% egg product and 90-99% plant oil, for example. A thickening or emulsifying agent can be used in substitution for an egg product emulsifier. The quantity of the egg yolk component of the adhesive paste may be in any amount that will result in an adhesive paste that adheres to a desired meat with minimum dripping or running. During the forming process, the degree of adhesion of the paste to the desired meat may be tested on the meat by applying the adhesive paste to the meat during the process of forming the adhesive paste, in order to achieve desirable adhesion. In this exemplary method of forming an adhesive paste, a quantity of egg product (egg yolk, for example) is provided in any container suitable for containing a paste. In the next step, an edible oil such as vegetable oil, for example, is slowly added to the egg product (whisked together with the egg product) until an emulsion is formed. At this point, more vegetable oil or egg product may be added until a desired degree of thickness of the paste is desired. In this example, the egg yolk acts as an emulsifier of the vegetable oil. A thickness of the paste should be such that it will adhere to a desired meat with minimal running or dripping. The adhesive paste according this embodiment of the present invention will adhere to pork meat with minimal dripping or running. Once the desired adhesiveness is obtained, the paste is ready to use. However, stabilizers and other components may be added as required by regulation.

### Second Embodiment

An adhesive paste according to another embodiment of the present invention can be made by first forming an emulsion according the first embodiment, but with plant oil in a range of 5-64% by weight, egg product in the range of 1-5% by weight and a plant paste in the range of 30-80% by weight, for example. The plant paste can be formed by first roasting one or more of vegetables or nuts or seeds (however, roasting is not necessary). The vegetables, nuts or seeds are then blended together at a high shear (in a blender, for example) to form a paste. An edible liquid such as water, a water product, fruit or vegetable juice, oil, or a milk product can be added during blending. The blending process may begin with equal amounts of vegetables or nuts or seeds and an equal amount of liquid. More liquid or vegetable nuts or seeds may be added while blending until the desired paste adhesion property of the paste is obtained. Suitable edible liquids may also include vegetable oil or animal oil. The resulting plant paste can next be blended together with the emulsion formed from the plant oil and egg product to form the adhesive paste. The adhesive paste is ready for use at this point. The adhesive paste according this embodiment of the present invention will adhere to pork meat with minimal dripping or running. An amount of plant paste used in this embodiment should not be so much that the paste will lose moisture and cake up prematurely. Other additives as required by regulation may be included in the paste. Flavorings as mentioned herein may also be added as desired.

### Third Embodiment

An adhesive paste according to another embodiment of the present invention can also be made using a dairy product such as a milk product in combination with an emulsion formed by the process of the first embodiment. In this embodiment, however, plant oil in the range of 5-50% by weight is blended with egg product in the range of 1-10% by weight to form a first emulsion. In this embodiment, high butterfat from milk is thickened or thinned to form a cream. The cream may then be blended with the plant oil and egg product emulsion of this embodiment. The cream may comprise 50-90% of the mixture by weight. The cream may be dried to a powder and mixed with the emulsion of this embodiment, for example. The cream may also be heated until a desired thickness is obtained. A desired consistency of the cream may be obtained by letting the cream sour naturally. A desired consistency of the cream may be obtained by adding bacteria to the cream. Bacteria can cause the cream to thicken. The adhesive paste obtained by combining a dairy milk product with a plant oil and egg product emulsion may be tested during the blending process to achieve the desired adhesive properties to a desired type of meat. The adhesive paste according this embodiment of the present invention will adhere to pork meat with minimal dripping or running.

### Fourth Embodiment

An adhesive paste according to another embodiment of the present invention can also be made using a dairy product such as a milk product in combination with a plant paste as formed in the third embodiment. In this embodiment, however, plant paste in the range of 5-75% by weight is blended with milk product in the range of 5-75% by weight to form the adhesive paste. In this embodiment, high butterfat from milk is thickened or thinned to form a cream. The cream may then be blended to the plant paste. The cream according to this embodiment may be formed by adding bacteria to ferment the cream. The cream may be dried to a powder and mixed with the emulsion of this embodiment, for example. The cream may also be heated until a desired thickness is obtained. A desired consistency of the cream may be obtained by letting the cream sour naturally. A desired consistency of the cream may be obtained by adding bacteria to the cream. Bacteria can cause the cream to thicken. Dairy cream fermentation processes are known in the art, and therefore will not be discussed in detail. The adhesive paste obtained by combining a dairy milk product (cream) with a plant paste may be tested during the blending process to achieve the desired adhesive properties to a desired type of meat. A plant paste portion comprising 50% or less of the total weight of the adhesive paste of this embodiment will minimize drying out or caking up of the adhesive paste. The adhesive paste according this embodiment of the present invention will adhere to pork meat with minimal dripping or running.

### Fifth Embodiment

An adhesive paste according to another embodiment of the present invention can also be formed using a dairy product such as a milk product in combination with an emulsion formed by the process of the first embodiment. In this embodiment, however, plant oil in the range of 5-64% by weight is blended with egg product in the range of 1-10% by weight to form a first emulsion. In this embodiment, high butterfat from milk is thickened or thinned to form a cream. The cream may then be blended to plant oil and egg product emulsion of this embodiment. The cream may comprise 50-95% of the mixture by weight. The cream may be dried to a powder and mixed with the emulsion of this embodiment, for example. The cream may also be heated until a desired thickness is obtained. A desired consistency of the cream may be obtained by letting the cream sour naturally. A desired consistency of the cream may be obtained by adding bacteria to the cream. Bacteria can cause the cream to thicken. The adhesive paste obtained by combining a dairy milk product with a plant oil and egg product emulsion may be tested during the blending process to achieve the desired adhesive properties to a desired type of meat. The adhesive paste according this embodiment of the present invention will adhere to pork meat with minimal dripping or running. However, the consistency should be that it is fairly easily spreadable. Some nut based products can be thinned substantially (adding moisture) to render them easily spreadable on a meat.

It is desirable that the adhesive paste of the present invention dissipates slowly during a cooking process, and that the adhesive paste does not burn during the cooking process. The adhesive paste is considered slow dissipating by either melting, evaporating or being absorbed into the meat gradually for a duration of a cooking time of the meat substantially. For example, for a cooking time of one hour, some of the paste should adhere to the meat for at least 30 minutes or more. The above embodiments produce an adhesive paste that dissipates slowly. That is, a residue of the adhesive paste can remain on a surface of the meat for the duration of the cooking process of the meat without burning. The adhesive paste may dissipate slowly by melting, by being absorbed into the meat or by evaporating. A sugar content of the adhesive paste should be managed (limited, for example) because sugar may burn over extended cooking times or high cooking temperatures. Alternatively, a temperature of a heat source of cooking time may be managed to regulate degree of dissipation of the adhesive paste, and to mitigate possible burning.

### Method of Using an Adhesive Paste

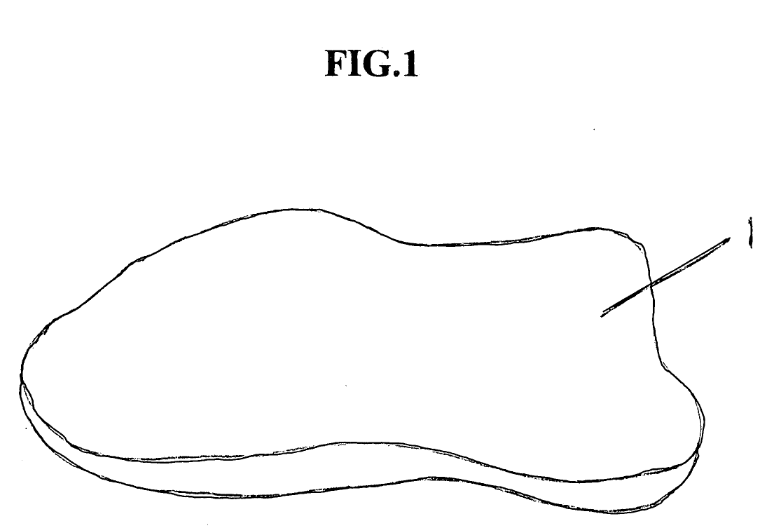

Referring to FIG. 1, an exemplary view of a meat 1 in slab form is illustrated. For illustration purposes, the meat 1 shown in FIG. 1 represents a meat which is at least about 15 inches long by about 6 inches wide and about 1 inch thick, for example. This dimension is only illustrative however, and does not limit a meat slab to this size. A slab may be square, for example. For purposes of this disclosure, meat can be defined as an animal meat such as, beef meat, pork meat, goat meat, fowl meat and fish, for example. For purposes of illustration, the meat can be a pork or beef meat in slab form (a pork rib rack in slab form, for example).

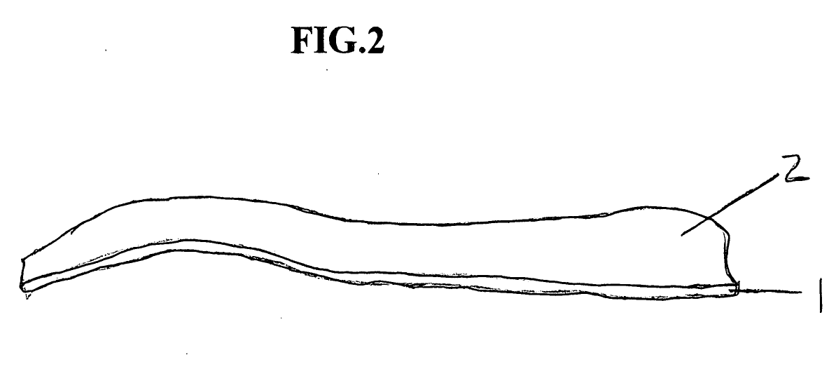

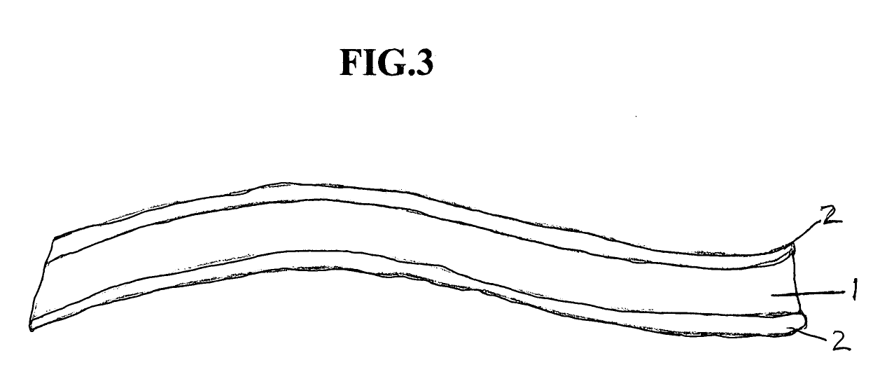

FIG. 2 illustrates the meat 1 having an adhesive paste 2 adhered to a lower surface thereof according to the present invention. FIG. 3 illustrates the meat 1 having an adhesive paste 2 adhered to an entire surface thereof. The meat 1 can be seasoned according to a user's taste or marinated in any traditional manner before the adhesive paste 2 is applied. The adhesive paste 2 may be applied when the meat 1 is placed into a heated environment for cooking of the meat 1, or immediately before the meat is introduced to the heated environment for cooking source. No pre-marinating of the meat 1 with the adhesive paste 2 is necessary. However, pre-marinating should not affect tenderizing as long as the paste 2 is not substantially diluted by the pre-marinating.

It is generally known that meat cut into small pieces will tenderize and cook quickly regardless of a method of cooking. Therefore, while the adhesive paste 2 can be effective in tenderizing small pieces of meat (meat with both widths and thicknesses of a few inches or less, for example), such small pieces of meat usually do not require added measures for tenderizing. While a width, length and thickness of a meat has been identified for example, a thickness of the meat 1 is the primary dimension of interest with respect to the present method of using. For purposes of tenderization, a width and length of the meat 1 is only limited by space available for cooking it.

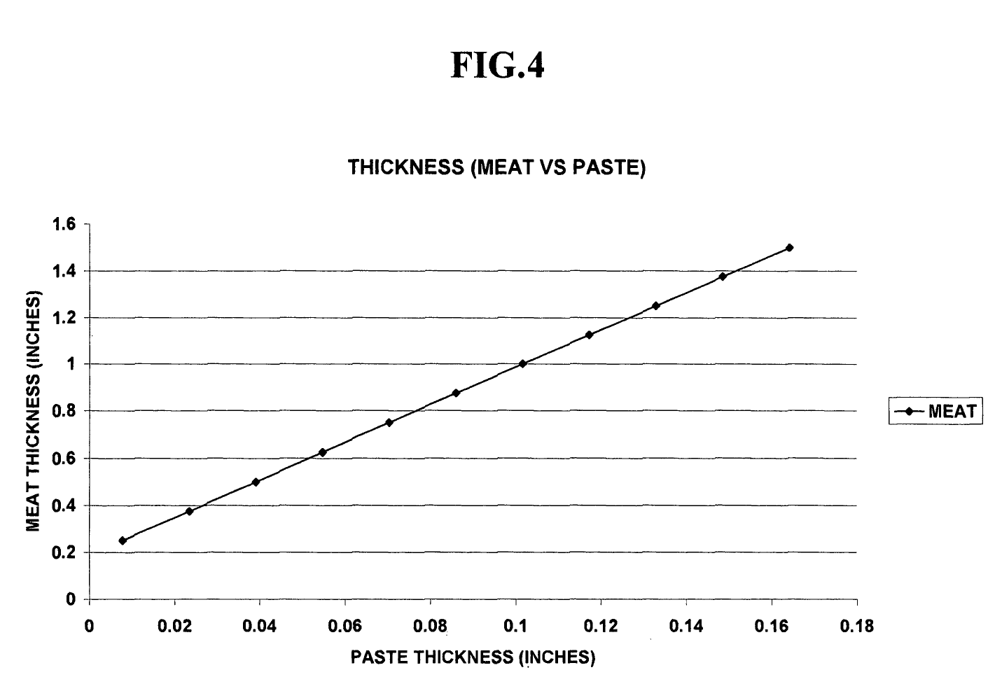

FIG. 4 is a graph illustrating a thickness of the meat 1 versus a thickness of the paste 2 for effective tenderizing. For the exemplary one inch thick meat 1, the adhesive paste 2 is applied at a thickness of about 0.1 to 0.3 inches to at least a lower surface of the meat. A lower surface can be defined as the surface that is closest to the heat source. A lower surface may be defined as the surface that will receive the most heat initially. When the meat is turned (or turns) during cooking, then the lower surface can become a different surface from the original lower surface, that is, the surface that is closest to the heat source. The adhesive paste 2 is effective in tenderizing the meat 1 when applied to only an upper surface of the meat 1, and the paste 2 is effective in tenderizing when applied to only an upper surface of the meat 1. The quantity of adhesive paste 2 applied should remain on the surface of the meat 1 substantially when first applied. If the adhesive paste 2 runs off of the meat or drips off of the meat substantially (5% or more, for example), then a maximum effectiveness of tenderizing according to the present invention may not be achieved. Nevertheless, some tenderizing can result. In such a case, for maximum effectiveness, at least one repeat application may be necessary during or before cooking the meat 1. Usually, however, only one application is necessary, and only one application is preferred. An application of the adhesive paste 2 at a thickness of about 0.1 to 0.13 inches is effective to tenderize slab meat having a thickness between about 0.8 and 1.2 inches during cooking. For meat thicknesses greater than 1.2 inches, a layer of adhesive paste 2 applied at a thickness of about 0.14 inches is effective in tenderizing the meat 1 during cooking. The application of the adhesive paste 2 according to the method of the present invention is effective in tenderizing meat slabs having thicknesses of two inches or more. The method is very effective on beef meat slabs of about 1 inch thick (skirt steak, flank steak, round, for example).

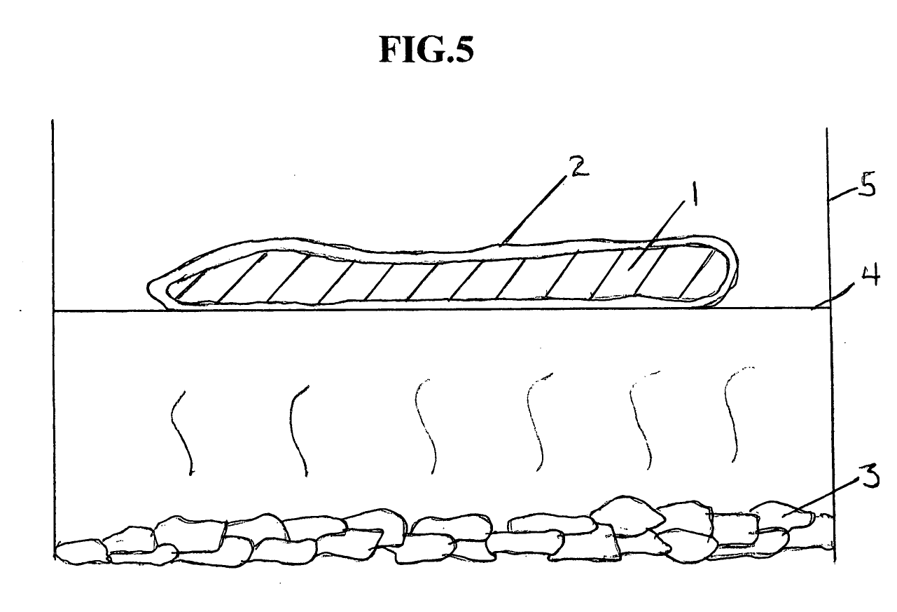

FIG. 5 shows a view of a meat 1 having an adhesive paste 2 adhered to an entire surface thereof. The meat 1 is held in suspension above a heat source 3 (5 to 12 inches, for example). In this example charcoals are a source of heat. For lower temperature heat sources, the meat 1 may be placed closer to the heat source 3 and for higher temperature heat sources, the meat 1 may be placed further away. In FIG. 5, the meat 1 is supported by a rack 4, and the rack 4 is supported by side supports 5. For the exemplary one inch thick meat slab, the heat source 3 can be prepared and allowed to stabilize at a temperature between 275 and 325 degrees Fahrenheit (for example) in the zone that the meat will be placed. The heat source 3 can be a lighted charcoal or wood heat source, a gas or electric heat source or any heat source suitable for cooking a meat. Charcoal, wood or gas heat which imparts a flavor to the meat 1 is preferable.

A thermometer may be used to monitor a cooking temperature of the meat 1 in an open or closed cooking environment. The adhesive paste 2 is also effective at temperatures lower than 275 degrees F. However, an advantageous feature of the present invention is the ability to cook a meat fast, at a higher than conventional temperature, and still obtain good flavor and tenderness. The adhesive paste 2 is also effective to tenderize a meat at temperatures greater than 325 degrees F. However, a consideration for appropriate cooking temperatures will be a prevention of burning of the meat or of the adhesive paste 2. The adhesive paste according to the present invention actually protects the surface of a meat from burning.

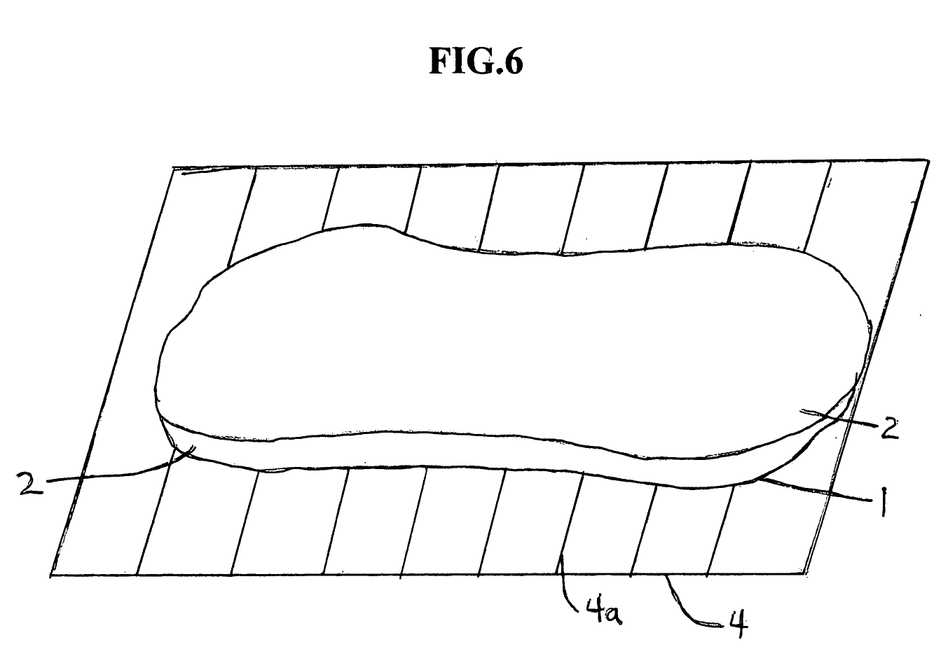

It is preferable that the meat be suspended above the heat source with at little contact with a surface of a rack 4 or grate as possible. FIG. 6 illustrates an example of the meat one being placed on the rack 4 with wire members 4a. The space between the wire members 4a allow for exposure of the meat to more heat and to flavor from the heat source. The meat 1 may also be placed on a spit. These measures will maximize flavor obtained from the heat source and minimize a surface area contact between the meat and a support. This, in turn, minimizes scorching between the meat 1 or adhesive paste 2 and the rack 4 or other support for the meat 1.

For the exemplary one inch thick meat slab 1, at the parameters set forth above, the meat is cooked and tenderized in about 30 minutes or less at the upper temperature range of 325 degrees F. and above. The inventors believe that the adhesive paste 2 actually contributes to a reduced cooking time. The meat 1 is tenderized in about 45 minutes or less at a temperature of about 300 degrees F. The meat 1 is tenderized in about one hour or less at a temperature of about 275 degrees F. According the present invention, the meat only needs to be turned once at about a half-way point of the cooking time duration. Basting the meat with the adhesive paste or any reapplication of the adhesive paste is not required and not preferred.

Depending a content of an adhesive paste according to the present invention, a small residue of paste may be desirable to remain on the meat for flavor or appearance. If a residue is desired, then an adhesive paste having a substantial plant (fruit, nut of vegetable) content may be used. A residue may also suffice as a type of barbeque sauce adhered to the meat for flavoring.

On the other hand, it may also be desirable that the adhesive paste dissipates completely from the surface of the meat. In this case, an adhesive paste having a substantial oil content may be used. A paste having a suitable amount of sugar content may be used if a sweeter residue is desired. A paste having a higher water content can reduce scorching or searing of the meat. A paste have a variety of colorations may be added for appearance of the meat. Molasses, vegetable powders, paprika or any other food coloring agent may be added to the paste for color, for example.

Depending on a composition of the adhesive paste, tenderization can be accomplished by one or more of the following:
1. Providing a long lasting moisture source on a surface of the meat causing moisture to be absorbed into the meat continually with one application of the adhesive paste.
2. Providing a long lasting barrier at a surface of the meat to prevent or slow the exit of internal juices from the meat during cooking.
3. Providing a barrier at a lower surface of the meat to slow down the exit of internal juices from the meat.
4. Providing a barrier at an upper surface of the meat to slow down or prevent evaporation of moisture from the meat.
5. Providing a moisture barrier at a lower surface of the meat to steam the meat continually.
6. Providing a complete seal to prevent exit of internal juices from the meat during cooking.

The adhesive paste according to the present invention and a method of using and adhesive paste does not rely on a meat tenderizer such as an enzyme. The adhesive paste and method of using does not rely on marinating a meat or pickling of a meat. The adhesive paste and method of using an adhesive paste is effective for tenderizing a meat at temperatures above an active range of a tenderizing enzyme. The adhesive paste and method of using an adhesive paste is effective at temperatures above 350 degrees F., for example. This temperature exceeds an active temperature range of a tenderizing enzyme. The adhesive paste and method of using an adhesive paste does not rely heavily on a specific composition or parameters or properties thereof. Rather, a degree of adhesiveness to a surface of a meat is a major contributing factor.

In addition to the inventor's new composition, some existing products may be used according to the method of using set forth herein. The method of using according to the present invention encompasses those existing products. Some existing mayonnaise and mayonnaise like products may be used according to the method disclosed herein. In case of a mayonnaise or mayonnaise-like product, it is here noted that the inventors' compositions are effective without vinegar, water, or citrus juices, though they may be included in the inventors' compositions. Some existing dairy products may be used according to the method disclosed herein. For example, some sour creams or sour cream substitutes may be used according to the present invention. Some existing plant products may be used according to the method disclosed herein. For example, some nut butters may be used according to the present invention. While some products exist, they have not been used heretofore to effect tenderizing of meat according the method disclosed herein. Further, the inventors have found that some of these products are slow melting, and some of these products do not meet the minimal dripping or running requirement of an adhesive paste to be used according to the present invention.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of using an adhesive paste for tenderizing meat, the method comprising:
providing a suitable amount of meat;
providing an adhesive paste, the adhesive paste having a consistency which enables it to adhere to a surface of the meat with minimal dripping or running;
applying the adhesive paste to at least a lower surface of the meat; and
exposing the meat to a heat source for cooking, wherein the meat is tenderized during cooking.

2. The method of using of claim 1, wherein a consistency of the adhesive paste is such that it adheres to a surface of the meat with minimum dripping or running.

3. The method of using of claim 1, wherein the adhesive paste is applied to the meat before exposing the meat to the heat source for cooking.

4. The method of using of claim 1, wherein the adhesive paste is applied to an entire surface of the meat.

5. The method of using of claim 1, wherein the adhesive paste is not used with a tenderizing enzyme.

6. The method of using of claim 1, wherein the adhesive paste tenderizes the meat outside of an active temperature range of a tenderizing enzyme.

7. The method of using of claim 1, wherein the adhesive paste is slow dissipating.

8. The method of using of claim 1, wherein the adhesive paste is slow melting.

9. The method of using of claim 1, wherein the adhesive paste is slow evaporating.

10. The method of using of claim 1, wherein the adhesive paste leaves a residue.

11. The method of using of claim 1, wherein the adhesive paste dissipates substantially during cooking.

12. The method of using of claim 1, wherein the adhesive paste tenderizes the meat based on a thickness of an application of the paste.

13. The method of using of claim 1, wherein the adhesive paste tenderizes the meat based on a duration of time of adhesion of the paste to the meat.

14. The method of using of claim 1, wherein the adhesive paste tenderizes the meat based on a type of meat.

15. The method of using of claim 1, wherein the adhesive paste tenderizes the meat based on a thickness of the meat.

16. The method of using of claim 1, wherein the adhesive paste tenderizes the meat based on duration of time of cooking the meat.

17. The method of using of claim 1, wherein the adhesive paste tenderizes the meat in less than 45 minutes.

18. The method of using claim 1, wherein the adhesive paste tenderizes the meat at temperature which exceeds an activation temperature of an enzyme used for tenderizing.

19. An adhesive paste for tenderizing meat, comprising:
a plant oil; and
a thickener of the plant oil, wherein the plant oil and the thickener are blended together to form an adhesive paste, the adhesive paste having a consistency which enables it to adhere to a surface of a meat with minimal dripping or running.

20. An adhesive paste for tenderizing meat, comprising:
a dairy product;
an emulsion, wherein the dairy product and the emulsion are blended together to form an adhesive paste, the adhesive paste having a consistency which enables it to adhere to a surface of a meat with minimal dripping or running.
